(19) United States
(12) Patent Application Publication
(10) Pub. No.: US 2015/0337773 A1
(43) Pub. Date: Nov. 26, 2015

(54) APPARATUS AND METHOD FOR SUPPLYING FUEL USING EGR COOLER

(71) Applicant: Hyundai Motor Company, Seoul (KR)

(72) Inventors: Yong Jun CHOI, Daegu (KR); In Kyun LEE, Gwangmyeong-si (KR)

(73) Assignee: Hyundai Motor Company, Seoul (KR)

(21) Appl. No.: 14/559,805

(22) Filed: Dec. 3, 2014

(30) Foreign Application Priority Data
May 21, 2014 (KR) 10-2014-0061146

(51) Int. Cl. F02M 25/07; F02M 31/20

(52) U.S. Cl. CPC F02M 25/0726; F02M 31/20

(57) ABSTRACT

An apparatus for supplying fuel to a diesel engine provided with an EGR cooler may include a first supply line for introducing fuel supplied from a fuel tank to the EGR cooler through a low pressure pump, a second supply line for introducing the fuel that passes through the EGR cooler to a common rail through a high pressure pump, and a first bypass line for bypassing a part of the fuel that passes through the low pressure pump to a fuel mixing section formed on a front of the high pressure pump of the second supply line so as to be mixed with fuel that is cooled while passing through the EGR cooler.

### CROSS-REFERENCE(S) TO RELATED APPLICATION

The present application claims priority to Korean Patent Application Number 10-2014-0061146 filed May 21, 2014, the entire contents of which is incorporated herein for all purposes by this reference.

### BACKGROUND OF THE INVENTION

1. Field of the Invention

The present invention relates to an apparatus and a method for supplying fuel using an EGR (Exhaust Gas Recirculation) cooler, and more particularly, to an apparatus and a method for supplying fuel using an EGR cooler in which a part of fuel that is supplied from a fuel tank is heat-exchanged in the EGR cooler to control the temperature of fuel that is supplied to a common rail.

2. Description of Related Art

Generally, the higher temperature of fuel, the greater efficiency of the fuel becomes until a predetermined level. Especially, referring to performance measurement and test results per temperature of gasoline fuel in a GDI (Gasoline Direct Injection) engine, it can be understood that as the temperature of fuel increases, overall performances of an engine such as stability of combustion and output increase. Such performance improvement of an engine is shown by the facts that as the temperature of fuel increases when the fuel is injected from an injector, fuel atomization and injection width thereof are increased up to a predetermined temperature. When applying these results to a direction injection type diesel engine, it can be inferred that fuel diffusion efficiency may be increased and a mixture with air may be made better until a predetermined temperature according to the increase of fuel atomization and injection width of fuel.

Meanwhile, FIG. 1A is a view illustrating a general fuel supply system of a diesel engine, and the general fuel supply system of an engine has a structure that fuel from a fuel tank 11 of a vehicle is pressure-increased through pumps 12, 14 and is supplied to an injector 16, as shown in FIG. 1a. That is, fuel is firstly pressure-increased through a low pressure pump 12 at a front of the fuel tank 11, and is supplied to a fuel supply line connected to the high pressure pump 14. At this time, fuel passes by a fuel temperature sensor 13 at a front of the high pressure pump 14. The fuel of a high pressure that is pressure-increased to 1800 bar (based on U2 EU5 engine) through the high pressure pump 14 is injected to a combustion chamber from an injector 16 through a common rail 15. The remaining fuel after being injected to the combustion chamber is returned back to the fuel tank 11 through a fuel return hose 17.

In the general supply system as described above, density of fuel can only be compensated according to the temperature of fuel measured through the temperature sensor 13 when injecting fuel from the injector 16. However, since it cannot maintain temperature at which optimum combustion is possible, there is a limitation to further improving combustion efficiency.

Further, FIG. 1B is a view illustrating a general EGR system wherein the currently used EGR system uses cooling water as refrigerant for cooling EGR gas. That is, a EGR cooler 23 cools EGR gas of a high temperature such that cooling water passes through a flow passage provided inside a EGR cooler 23 and the EGR gas of a high temperature that is circulated from an exhaust manifold 21 passes around the EGR cooler, and then is re-circulated to an intake manifold 26 wherein the flow of EGR gas may be blocked or bypassed through an EGR valve 22 and a bypass valve for EGR gas 24 according to regions where the EGR system is used. Further, the temperature sensor for EGR gas is provided to measure the temperature of EGR gas and the measured value is used.

At this time, the cooling water used as refrigerant is the cooling water used for an engine 30, and its temperature is kept at around 80° C. However, a cooling efficiency may increase as the temperature of refrigerant further decreases.

Accordingly, the present applicant implemented the present invention based on the facts that combustion efficiency of fuel can be improved by controlling the temperature of the fuel while improving cooling efficiency of EGR system by using fuel that is supplied by a diesel engine as a refrigerant of EGR system.

Meanwhile, a technology which increases temperature of oil or cooling water through a recovery device of heat exhausted from an engine has been proposed and used according to a related art.

According to the related art, temperature rise of cooling water and oil is induced thereby to improve fuel ratio of a vehicle under a situation where fuel is consumed greatly such as starting-on, rapid starting, rapid acceleration or a high speed driving of a vehicle, and unnecessary heat exchange of cooling water can be prevented under a situation where heat exchange of cooling water is not necessary, thereby preventing performance decrease of components of a vehicle which uses cooling water. However, it cannot be expected to improve combustion performance of fuel.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus and a method for supplying fuel using EGR cooler in which a part of fuel that is supplied from a fuel tank is heat-exchanged in the EGR cooler to control the temperature of fuel that is supplied to a common rail.

Further, various aspects of the present invention are directed to providing an apparatus and a method for supplying fuel using EGR cooler in which cooling efficiency of EGR gas can also be improved as fuel that has lower temperature than cooling water is used as refrigerant in the EGR cooler.

According to various aspects of the present invention, an apparatus for supplying fuel to a diesel engine using an EGR cooler may include a first supply line for introducing fuel supplied from a fuel tank to the EGR cooler through a low pressure pump, a second supply line for introducing the fuel that passes through the EGR cooler to a common rail through a high pressure pump, and a first bypass line for bypassing a part of the fuel that passes through the low pressure pump to a fuel mixing section formed on a front of the high pressure pump of the second supply line so as to be mixed with fuel that is cooled while passing through the EGR cooler.

A fuel temperature sensor for measuring a temperature of fuel between the fuel mixing section and the high pressure pump may be provided on the second supply line and a second bypass line for introducing a part of the fuel that passes through the low pressure pump to the first bypass line according to the fuel temperature value measured at the fuel temperature sensor is provided on the first supply line.

A 3-way valve for controlling the amount of fuel that is introduced into the EGR cooler and the second bypass line may be provided at a connection point of the first supply line and the second bypass line, and the 3-way valve may be controlled to adjust the amount of fuel that is introduced into the EGR cooler and the second bypass line according to the fuel temperature value measured at the fuel temperature sensor.

According to various aspects of the present invention, a method for supplying fuel to a diesel engine provided with an EGR cooler may include controlling a part of fuel to pass through an EGR cooler and then be supplied to a common rail so as to control a temperature of fuel supplied from a fuel tank.

The method for supplying fuel to the diesel engine provided with the EGR cooler may further include firstly pressure-increasing fuel supplied from the fuel tank at the low pressure pump, allowing a part of the fuel that is firstly pressure-increased to pass through the EGR cooler and the rest thereof to bypass the EGR cooler to be mixed with each other, secondly pressure-increasing the mixed fuel at the high pressure pump, and supplying the fuel that is secondly pressure-increased to the common rail.

The method for supplying fuel to the diesel engine provided with the EGR cooler may further include measuring a temperature of the mixed fuel and controlling the amount of fuel that passes through the EGR cooler and the amount of fuel that bypasses the EGR cooler based on the measured fuel temperature value.

The step of controlling the amount of fuel that passes through the EGR cooler and the amount of fuel that bypasses the EGR cooler may include increasing the amount of fuel that passes through the EGR cooler when the measured fuel temperature value is lower than a set optimal temperature value and increasing the amount of fuel that bypasses the EGR cooler when the measured fuel temperature value is higher than the set optimal temperature value.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A is a view illustrating schematically a fuel supply system of a diesel engine according a related art.

FIG. 1B is a view illustrating schematically an EGR system according to a related art.

FIG. 2 is a view illustrating an exemplary apparatus for supplying fuel using an EGR cooler according to the present invention.

FIG. 3A and FIG. 3B are views illustrating a flow of fuel and EGR gas when using the exemplary apparatus for supplying fuel using the EGR cooler according to the present invention.

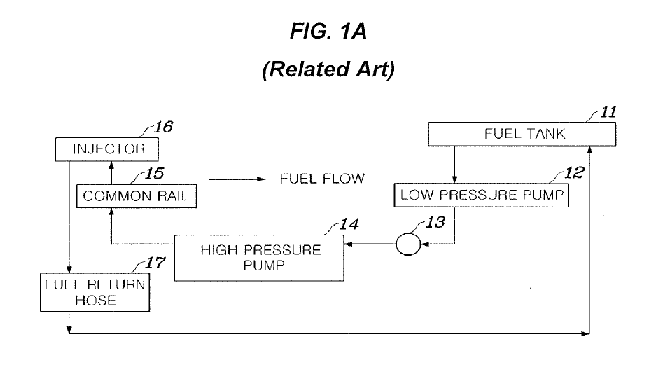

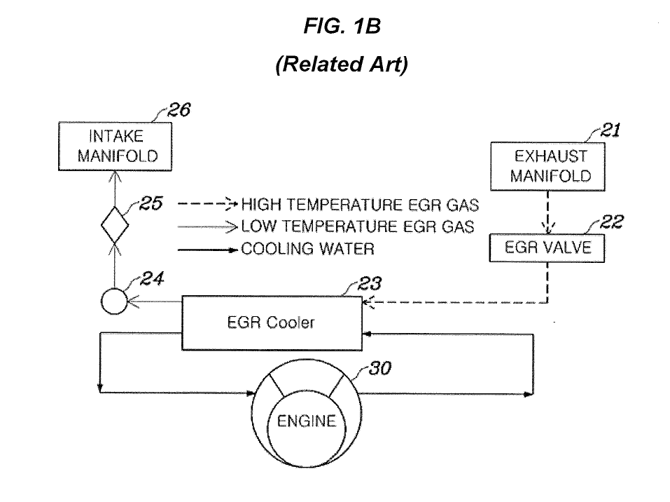

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

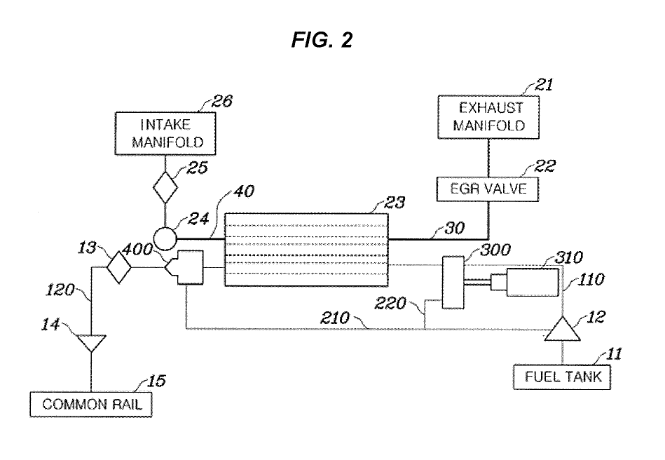

FIG. 2 is a view illustrating an apparatus for supplying fuel using an EGR cooler according to an embodiment of the present invention.

As shown in FIG. 2, the apparatus for supplying fuel using an EGR cooler according to various embodiments of the present invention is mainly composed of a structure for implementing an EGR system and a structure for a fuel supply system, in which firstly a first circulation gas line 30 for introducing EGR gas that is circulated from an exhaust manifold 21 to an EGR cooler 23 and a second circulation gas line 40 for re-circulating the EGR gas that is heat-exchanged in the EGR cooler 23 to an intake manifold 26 are provided in the structure for implementing an EGR system. At this time, an EGR valve 22 is provided on the first circulation gas line 30, a bypass valve for EGR gas 24 for blocking or bypassing the flow of EGR gas and a temperature sensor for EGR gas 25 for measuring temperature of EGR gas are provided on the second circulation gas line 40.

Next, there are provided on the structure for a fuel supply system a first supply line 110 for introducing fuel supplied from a fuel tank 11 to an EGR cooler 23, a second supply line 120 for introducing the fuel that passes through the EGR cooler 23 to a common rail 15, and a first bypass line 210 for bypassing a part of fuel that is supplied to the first supply line 110 from the fuel tank 11 to the second supply line 120. Further, a second bypass line 220 is provided on a front of the EGR cooler 23 for bypassing a part of fuel that flows along the first supply line 110 to the first bypass line 210.

Here, a low pressure pump 12 is provided on the first supply line 110 for firstly pressure-increasing the fuel supplied from the fuel tank 11, and further one end of the first bypass line 210 that is branched from the first supply line 110 is connected to a rear of the low pressure pump 12 and the other end of the first bypass line 210 is connected to the second supply line 120. At this time, a connection point of the other end of the first bypass line 210 and the second supply line 120 refers to “fuel mixing section 400”. Accordingly, a part of fuel that is firstly pressure-increased in the low pressure pump 12 is temperature-increased by heat-exchange with EGR gas while passing through the EGR cooler 23 along the first supply line 110 and is introduced into the fuel mixing section 400, and the rest of fuel that is firstly pressure-increased is directly introduced into the fuel mixing section 400 along the first bypass line 210 to be mixed with each other, thereby maintaining proper temperature and pressure thereof

Further, a fuel mixing section 400, a fuel temperature sensor 13, and a high pressure pump 14 are provided in sequence in a progress direction of fuel on the second supply line 120. Accordingly, the temperature of fuel that is mixed at a proper temperature and pressure in the fuel mixing section 400 is measured while passing through the fuel temperature sensor 13 and then is secondly pressure-increased to a level required at the common rail 15 while passing through the high pressure pump 14 to be supplied to the common rail 15.

Meanwhile, a second bypass line 220 is provided on the first supply line 110 for introducing a part of fuel that passes through the low pressure pump 12 according to the temperature value measured at the fuel temperature sensor 13 to the first bypass line 210. At this time, a 3-way valve 300 is provided at a connection point of the first supply line 110 and the second bypass line 220 for controlling the amount of fuel that is introduced into the EGR cooler 23 and the second bypass line 220, and is provided with a solenoid 310 for controlling opening/closing degree thereof

As a result, when the fuel temperature measured at the fuel temperature sensor 13 is lower than the set optimal temperature, the fuel induced into the first bypass line 210 through the second bypass line 220 is fully blocked or the amount thereof is decreased such that the amount of fuel that is temperature-increased at the EGR cooler 23 is increased as the amount of fuel that passes through the EGR cooler 23 is increased.

On the contrary, when the fuel temperature measured at the fuel temperature sensor 13 is higher than the set optimal temperature, the amount of fuel that is induced into the first bypass line 210 through the second bypass line 220 is increased such that the amount of fuel that is temperature-increased at the EGR cooler 23 is decreased as the amount of fuel that bypasses to the fuel mixing section 400 without passing through the EGR cooler 23 is increased.

Meanwhile, a method for supplying fuel by using the apparatus for supplying fuel using an EGR cooler according to various embodiments of the present invention will be described referring to the drawings.

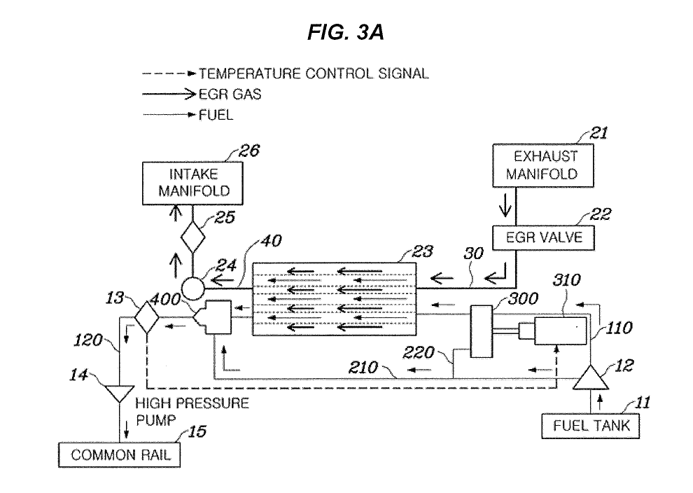

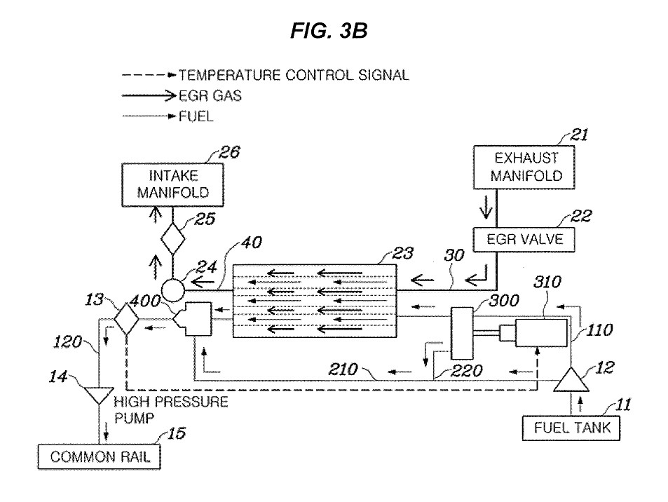

FIG. 3A and FIG. 3B are views illustrating a flow of fuel and EGR gas when using an apparatus for supplying fuel using an EGR cooler according to various embodiments of the present invention.

As shown in the drawings, a basic concept of the method for supplying fuel using an EGR cooler according to various embodiments of the present invention is based on the way that a part of fuel is introduced into an EGR cooler 23 for inducing heat-exchange with EGR gas and increasing the temperature and then is supplied to a common rail 15 so as to control temperature of fuel that is supplied to the common rail 15 from a fuel tank 11.

In other words, the low temperature of fuel is increased such that the amount of fuel that is introduced into the EGR cooler 23 is increased to rapidly increase the fuel temperature up to a proper temperature while driving at a section of a winter season (cold condition)/middle load. To this end, as shown in FIG. 3A, the fuel supplied from the fuel tank 11 is firstly pressure-increased at a low pressure pump 12 and a part of the fuel that is firstly pressure-increased is temperature-increased while passing through the EGR cooler 23 along the first supply line 110, to be supplied to a fuel mixing section 400 and the rest thereof is supplied to the fuel mixing section 400 while maintaining the firstly increased-pressure with bypassing the EGR cooler 23. At this time, the bypass of fuel from the first supply line 110 to the first bypass line 210 is blocked by closing the second bypass line 220.

As described above, the fuel that is temperature-increased while passing through the EGR cooler 23 and the fuel that is firstly pressure-increased while bypassing the EGR cooler 23 are mixed at the fuel mixing section 400 to maintain proper temperature and pressure.

The temperature of the fuel that is mixed at the proper temperature and pressure is measured while passing through the fuel temperature sensor 13 and then is secondly pressure-increased to a level required for the common rail 15 while passing through the high pressure pump 14 to be supplied to the common rail 15.

Meanwhile, when a fuel temperature value measured at the fuel temperature sensor 13 is higher than the set optimal temperature or driving a vehicle at a section of a warm condition/middle load, as shown in FIG. 3B, a part of fuel is to be bypassed to the second bypass line 220 by controlling the 3-way valve 300 thereby to maintain an optimal temperature as the temperature of fuel that is mixed at the fuel mixing section 400 lowers.

Further, when a fuel temperature value measured at the fuel temperature sensor 13 is lower than the set optimal temperature value while supplying fuel at the above state, the amount of fuel that is bypassed to the second bypass line 220 is decreased or fully blocked by controlling again the 3-way valve 300, thereby increasing the temperature of fuel that is mixed at the fuel mixing section 400.

As described above, the amount of fuel that passes through the EGR cooler 23 or bypasses the EGR cooler 23 is properly controlled according to the temperature value measured at the fuel temperature sensor 13 or driving condition, thereby maintaining optimum temperature of fuel to improve combustion efficiency thereof.

According to various embodiments of the present invention, a part of fuel that is supplied from fuel tank is heat-exchanged in an EGR cooler to increase the temperature of fuel that is supplied to a common rail, and is mixed with the rest thereof that bypasses the EGR cooler to control the temperature thereby to improve combustion efficiency.

Further, the fuel that has lower temperature than the cooling water is used as refrigerant of an EGR cooler to heat-exchange EGR gas thereby to improve cooling efficiency of EGR gas.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for supplying fuel to a diesel engine provided with an EGR cooler, comprising:
a first supply line for introducing fuel supplied from a fuel tank to the EGR cooler through a low pressure pump;
a second supply line for introducing the fuel that passes through the EGR cooler to a common rail through a high pressure pump; and
a first bypass line for bypassing a part of the fuel that passes through the low pressure pump to a fuel mixing section formed on a front of the high pressure pump of the second supply line so as to be mixed with fuel that is cooled while passing through the EGR cooler.

2. The apparatus for supplying fuel to the diesel engine provided with the EGR cooler of claim 1, wherein a fuel temperature sensor for measuring a temperature of fuel between the fuel mixing section and the high pressure pump is provided on the second supply line and a second bypass line for introducing a part of the fuel that passes through the low pressure pump to the first bypass line according to the fuel temperature value measured at the fuel temperature sensor is provided on the first supply line.

3. The apparatus for supplying fuel to the diesel engine provided with the EGR cooler of claim 2, wherein a 3-way valve for controlling the amount of fuel that is introduced into the EGR cooler and the second bypass line is provided at a connection point of the first supply line and the second bypass line, and the 3-way valve is controlled to adjust the amount of fuel that is introduced into the EGR cooler and the second bypass line according to the fuel temperature value measured at the fuel temperature sensor.

4. A method for supplying fuel to a diesel engine provided with an EGR cooler, comprising controlling a part of fuel to pass through an EGR cooler and then be supplied to a common rail so as to control a temperature of fuel supplied from a fuel tank.

5. The method for supplying fuel to the diesel engine provided with the EGR cooler of claim 4, further comprising:
firstly pressure-increasing fuel supplied from the fuel tank at the low pressure pump;
allowing a part of the fuel that is firstly pressure-increased to pass through the EGR cooler and the rest thereof to bypass the EGR cooler to be mixed with each other;
secondly pressure-increasing the mixed fuel at the high pressure pump; and
supplying the fuel that is secondly pressure-increased to the common rail.

6. The method for supplying fuel to the diesel engine provided with the EGR cooler of claim 5, further comprising measuring a temperature of the mixed fuel and controlling the amount of fuel that passes through the EGR cooler and the amount of fuel that bypasses the EGR cooler based on the measured fuel temperature value.

7. The method for supplying fuel to a diesel engine provided with the EGR cooler of claim 6, wherein the step of controlling the amount of fuel that passes through the EGR cooler and the amount of fuel that bypasses the EGR cooler includes increasing the amount of fuel that passes through the EGR cooler when the measured fuel temperature value is lower than a set optimal temperature value and increasing the amount of fuel that bypasses the EGR cooler when the measured fuel temperature value is higher than the set optimal temperature value.
